(19) United States
(12) Patent Application Publication
(10) Pub. No.: US 2011/0026927 A1
(43) Pub. Date: Feb. 3, 2011

(54) Transmission apparatus, transmission system, and method of communication

(75) Inventors: Toshiki Tanaka, Kawasaki (JP); Takeshi Hoshida, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/805,241

(22) Filed: Jul. 20, 2010

(30) Foreign Application Priority Data
Aug. 3, 2009 (JP) 2009-180937

(51) Int. Cl. H04J 14/02

(52) U.S. Cl. 398/81

(57) ABSTRACT

A transmission apparatus is provided. The transmission apparatus in a transmission system that performs dispersion compensation on a transmission line includes a receiver, an information collection unit and a chromatic dispersion providing unit. The receiver receives a wavelength division multiplexing optical signal for each wavelength from the transmission line. The information collection unit collects information regarding a reception method applied to each wavelength of the optical signal received by the receiver, as reception method information. The chromatic dispersion providing unit provides respective chromatic dispersion amounts different from each other to an optical signal received using a digital coherent reception method and an optical signal received using a reception method other than the digital coherent reception method, based on the information regarding a reception method collected by the information collection unit.

### CROSS-REFERENCE TO RELATED APPLICATION(S)

This application is related to and claims priority to Japanese Patent Application No. 2009-180937, filed on Aug. 3, 2009, and incorporated herein by reference.

### BACKGROUND

1. Field

The embodiments discussed herein are directed to a transmission apparatus, a transmission system, and a method of communication.

2. Description of the Related Art

In wavelength division multiplexing (WDM) optical communications systems, a technology for receiving optical signals using a digital coherent reception method has been the focus of considerable attention. In the digital coherent reception method, received signal processing is performed through digital signal processing using optical interference between local laser light and received signal light. By using this method, optical noise immunity can be improved. Furthermore, compared with differential direct detection, the ability to compensate for chromatic dispersion distortion using electrical signal processing subsequent to photoelectric conversion is considered to be significantly increased.

In the WDM optical communications systems, it may be desired to change a reception method to the digital coherent reception method on a wavelength by wavelength basis, which is a component of wavelength multiplexing. That is, a received signal processing module in a receiver may be replaced on a wavelength by wavelength basis, for example, through exchange.

Changing a reception method on a wavelength by wavelength basis may allow modules for other channels in operation to be prevented from being halted. Accordingly, a system may be replaced stepwise in accordance with an increase in the amount of communication in operation, resulting in an advantage in terms of cost.

For example, regarding a receiver module for a wavelength for which a reception method is to be changed, a module may use direct detection method that converts a strength modulation signal to an electrical signal using a photoelectric converter is changed to a module that performs digital coherent reception. As another example, a module can use a reception method performing differential detection for a phase modulated signal is changed to a module that performs digital coherent reception.

A related art is disclosed in Japanese Laid-open Patent Publication No. 8-321805.

Conventionally, a receiver module is designed assuming that, on a transmission path between transmission/reception apparatuses, a chromatic dispersion compensation ratio (dispersion compensation ratio) in each span is set at about 100%, due to a limit in the dispersion compensation capability of the transmission/reception apparatuses. In other words, about 100% of the amount of chromatic dispersion of a transmission path is compensated for by a repeater.

However, in communication employing the digital coherent reception method, it is necessary to improve the quality of received signals while supporting transmission systems with higher transmission speeds.

### SUMMARY

It is an aspect of the embodiments discussed herein to provide a transmission apparatus, a transmission system, and a transmission method.

The above aspects can be attained by an apparatus in a transmission system that performs dispersion compensation on a transmission line includes a receiver, an information collection unit and a chromatic dispersion providing unit. The receiver receives a wavelength division multiplexing optical signal for each wavelength from the transmission line. The information collection unit collects information regarding a reception method applied to each wavelength of the optical signal received by the receiver, as reception method information. The chromatic dispersion providing unit provides respective chromatic dispersion amounts different from each other to an optical signal received using a digital coherent reception method and an optical signal received using a reception method other than the digital coherent reception method, based on the information regarding a reception method collected by the information collection unit.

The above aspects can be attained by a transmission system for performing dispersion compensation on a transmission line including a receiver to receive from the transmission line a wavelength division multiplexing optical signal for each wavelength, an information collection unit to collect information regarding a reception method applied to each wavelength of the optical signal received by the receiver, as reception method information, and a chromatic dispersion providing unit that provides respective chromatic dispersion amounts different from each other to an optical signal received using a digital coherent reception method and an optical signal received using a reception method other than the digital coherent reception method based on the reception method information collected by the information collection unit. The above aspects can be attained by a method of communication in a transmission system that performs dispersion compensation on a transmission line including receiving from the transmission line a wavelength division multiplexing optical signal for each wavelength, collecting information regarding a reception method applied to each wavelength of the received optical signal as reception method information, selecting, for each wavelength, a first path or a second path in accordance with the applied reception method, based on the collected reception method information, and providing respective chromatic dispersion amounts different from each other to an optical signal received using a reception method other than a digital coherent reception method, on the first path, and to an optical signal received using the digital coherent reception method, on the second path.

The object and advantages of the various embodiments will be realized and attained by means of the elements and combinations particularly pointed out in the claims. It is to be understood that both the foregoing general description and the following detailed description are exemplary and explanatory and are not restrictive of the various embodiments, as claimed. These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an exemplary optical transmission system according to an embodiment;

FIG. 2 illustrates an exemplary transmission unit;

FIG. 3 illustrates an exemplary receiver unit;

FIG. 4 illustrates a dispersion compensation scheme in an optical transmission system;

FIG. 5 illustrates a result of an exemplary study on transmission characteristics in a digital coherent reception method;

FIG. 6 illustrates an exemplary configuration of a receiver using the digital coherent reception method and an exemplary method of transmitting control information from the receiver to an information extraction unit;

FIG. 7 illustrates an exemplary operation of an embodiment;

FIG. 8 illustrates an exemplary modification of an embodiment;

FIG. 9 illustrates an exemplary modification of an embodiment;

FIG. 10 illustrates an exemplary modification of an embodiment;

FIG. 11 illustrates an exemplary modification of an embodiment; and

FIG. 12 illustrates an exemplary modification of an embodiment.

### DETAILED DESCRIPTION OF THE EMBODIMENTS

An exemplary embodiment is described with reference to the drawings. The embodiment described is only an example, and is not intended to exclude other various modifications and applications of technologies not explicitly described below. In other words, an embodiment can be realized in various modifications within the scope of the embodiment.

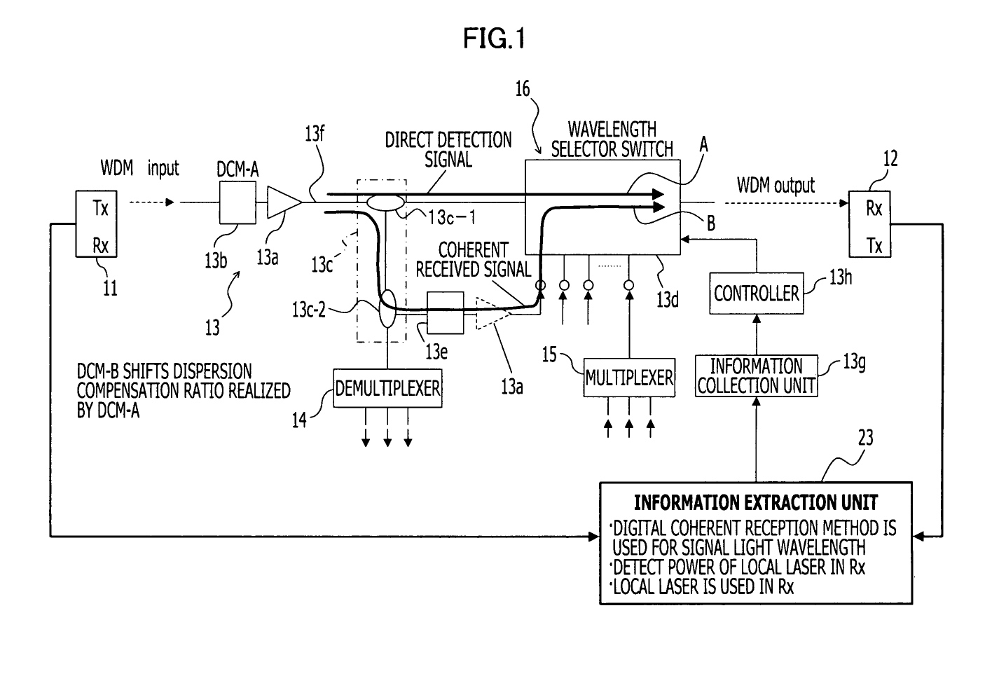

FIG. 1 illustrates an example of an optical transmission system according to an embodiment. Transmission apparatuses 11 and 12 each include a transmission unit Tx and a receiver unit Rx and may be connected to each other via, for example, an optical transmission line 13. WDM signal light output from the transmission unit Tx of the transmission apparatus 11 may be transmitted to the receiver unit Rx of the transmission apparatus 12 via the optical transmission line 13.

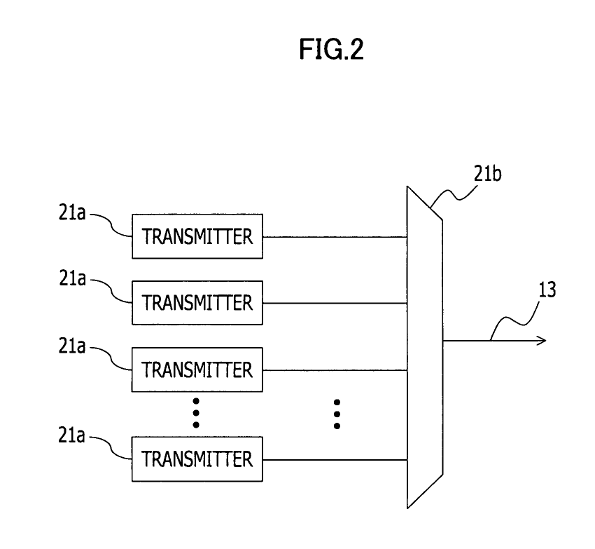

FIG. 2 illustrates an exemplary configuration of the transmission unit Tx which may be included in the transmission apparatus 11. Signal light components of WDM signal light have wavelengths which may be different among channels. For example, the transmission unit Tx includes a plurality of transmitters 21a for transmitting optical signals having different wavelengths from one another, as described above, and a multiplexer 21b for multiplexing optical signals from the transmitters 21a on a WDM basis and transmitting the signals as a WDM optical signal over the optical transmission line 13.

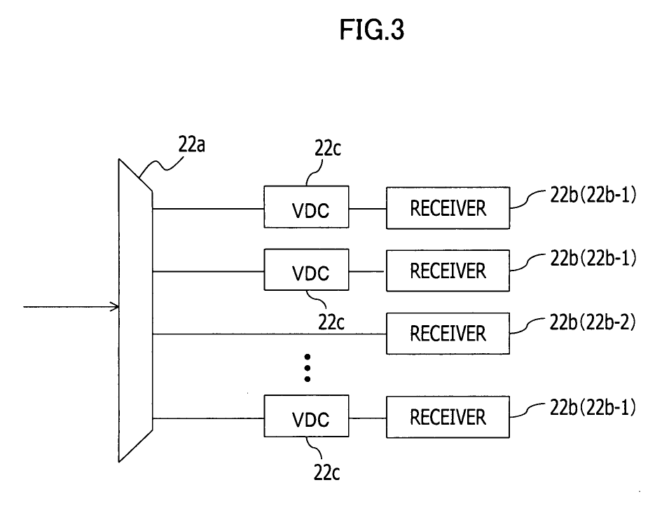

FIG. 3 illustrates an exemplary configuration of the receiver unit Rx which may be included in the transmission apparatus 12. The receiver unit Rx includes a demultiplexer 22a for demultiplexing WDM signal light transmitted from the optical transmission line 13 into signal light components of the WDM signal light based on the wavelengths thereof and receivers 22b for performing reception processing for optical signals corresponding to respective wavelengths obtained through demultiplexing by the demultiplexer 22a.

The receivers 22b may be of different types, such as a receiver (22b-1) configured to receive signals for which a direct detection method is used and a receiver (22b-2) configured to receive signals for which a digital coherent reception method is used. Variable dispersion compensators (VDCs) 22c may be provided between the demultiplexer 22a and the receivers 22b other than those configured to receive signals for which the digital coherent reception method is used.

The optical transmission line 13 may include an optical fiber 13f and a transmission apparatus 16 as a repeater therein. The optical transmission line 13 may appropriately include an optical amplifier 13a therein. The transmission apparatus 16 may include a dispersion compensating module (DCM-A) 13b for compensating for chromatic dispersion generated on the upper-stream side of the optical transmission line 13 and a configuration for allowing an optical signal having a given wavelength within WDM signal light to be added or dropped. The transmission apparatus 16 may be provided in a plurality and placed at approximately equal intervals, for example.

In the dispersion compensating module 13b, chromatic dispersion generated due to light propagation through the optical fiber 13f on the upper-stream side is compensated for. In other words, the dispersion compensating module 13b provides chromatic dispersion such that the chromatic dispersion generated in the optical fiber 13f on the upper-stream side is canceled out (decreased to nearly zero).

The transmission apparatus 16 includes a branching unit 13c for dropping an optical signal and a wavelength selector switch 13d for making an optical signal pass therethrough or adding an optical signal. The branching unit 13c and the wavelength selector switch 13d may be components of the transmission apparatus 16 that adds/drops an optical signal on a wavelength by wavelength basis.

The branching unit 13c drops part of a WDM optical signal input through the optical transmission line 13, and outputs the rest of the optical signal as two branch optical signals. In FIG. 1, the branching unit 13c is constituted by two spritters 13c-1 and 13c-2.

The spritter 13c-1, whose input side may be connected to the optical transmission line 13, divides a WDM optical signal input from the optical transmission line 13 into two optical signals, one guided to an input port of the wavelength selector switch 13d and the other guided to the spritter 13c-2. The spritter 13c-2, whose input side may be connected to an output of the spritter 13c-1, divides an optical signal from the spritter 13c-1 into two optical signals, one guided to a dropping path, and the other guided to a path leading to an input port of the wavelength selector switch 13d. A demultiplexer 14 may be connected to a path for dropping signals.

The wavelength selector switch 13d may be an N-input 1-output switch (N is, for example, equal to or above 3) and receives the two optical signals, other than the one to be dropped at the branching unit 13c, and optical signals to be added, which are respectively input to different input ports of the wavelength selector switch 13d. Optical signals having selected wavelengths among the optical signals input from the respective ports are output from the output port to the subsequent stage as WDM signal light in which specified wavelengths have been dropped/added.

In other words, when an optical signal input to the transmission apparatus 16 from the upper-stream side optical transmission line 13 is output to the optical transmission line 13 in the subsequent stage, there are two paths A and B, having dispersion amounts different from each other, through which the optical signal passes. The path A is a path starting from the branch node of the spritter 13c-1 and extending through the wavelength selector switch 13d, and the path B is a path starting from the branch node of the spritter 13c-1 and extending through the branch node of the spritter 13c-2, the dispersion compensating module 13e, and the wavelength selector switch 13d. Note that a multiplexer 15 for adding signals may be connected to the input port.

In the transmission apparatus 16 of an embodiment, dispersion compensation amounts in accordance with the configurations of the receivers for respective wavelengths including the receiver unit Rx of the transmission apparatus 12 can be added in addition to the above-described dispersion compensation amount provided by the dispersion compensating module 13b. In the transmission apparatus 16 illustrated in FIG. 1, a dispersion compensating module 13e is provided on the optical path between the spritter 13c-2 and the input port of the wavelength selector switch 13d.

The dispersion compensating module 13e provides a chromatic dispersion amount that causes the chromatic dispersion of an optical signal from the spritter 13c-2 to have a compensation amount which is different from the compensation amount provided by the dispersion compensating module 13b. For example, the dispersion compensating module 13e provides a chromatic dispersion amount that cancels out the chromatic dispersion compensation provided by the dispersion compensating module 13b.

For example, when the receiver for a certain wavelength including the receiver unit Rx of the transmission apparatus 12 is a receiver using a direct detection method, the wavelength selector switch 13d is operated such that light from the spritter 13c-1 corresponding to the wavelength is guided to the output port. On the other hand, when the receiver for another wavelength including the receiver unit Rx of the transmission apparatus 12 is a receiver using the digital coherent reception method, the wavelength selector switch 13d is operated such that light from the spritter 13c-2 corresponding to the wavelength is guided to the output port.

Thereby, regarding optical signals to which the digital coherent reception method was applied, an optical signal for which dispersion compensation has not been performed by the dispersion compensating module 13b on the optical transmission line 13 can be guided to the receiver unit Rx of the transmission apparatus 12. On the other hand regarding optical signals to which the digital coherent reception method was not applied, an optical signal for which dispersion compensation has been performed by the dispersion compensating module 13b on the optical transmission line 13 can be guided to the receiver unit Rx of the transmission apparatus 12.

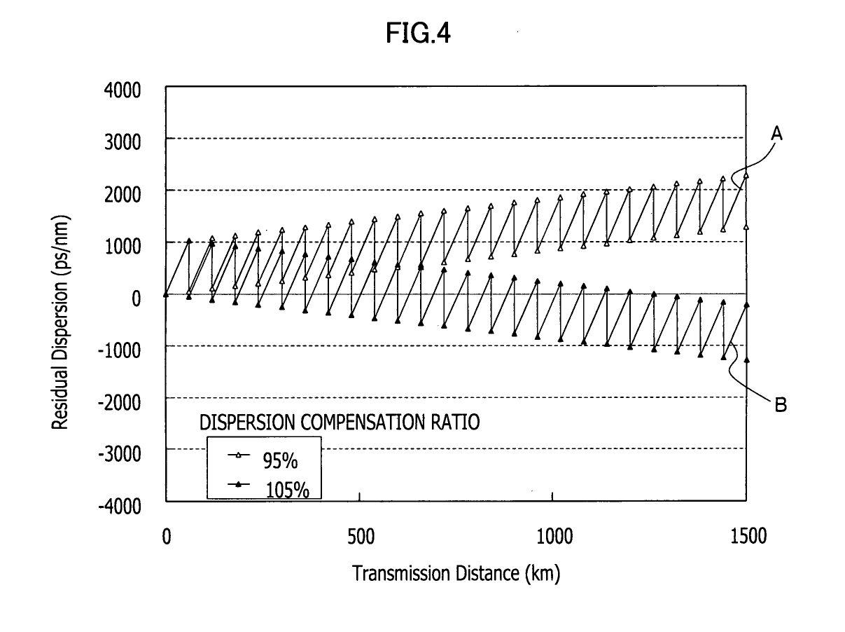

FIG. 4 illustrates a dispersion compensation in an optical transmission system. Referring to FIG. 4, dispersion compensation with a dispersion compensation ratio of about 100% (A: 95%, B: 105%) is performed in each span, which is a distance between repeaters. The dispersion compensation here corresponds to the dispersion compensation performed by the dispersion compensating module 13b illustrated in FIG. 1. However, dispersion compensation with a dispersion compensation ratio of about 100% performed in each span, as described above, does not necessarily result in high-quality received signals in the case of introducing receivers using the digital coherent reception method, which has recently been under study.

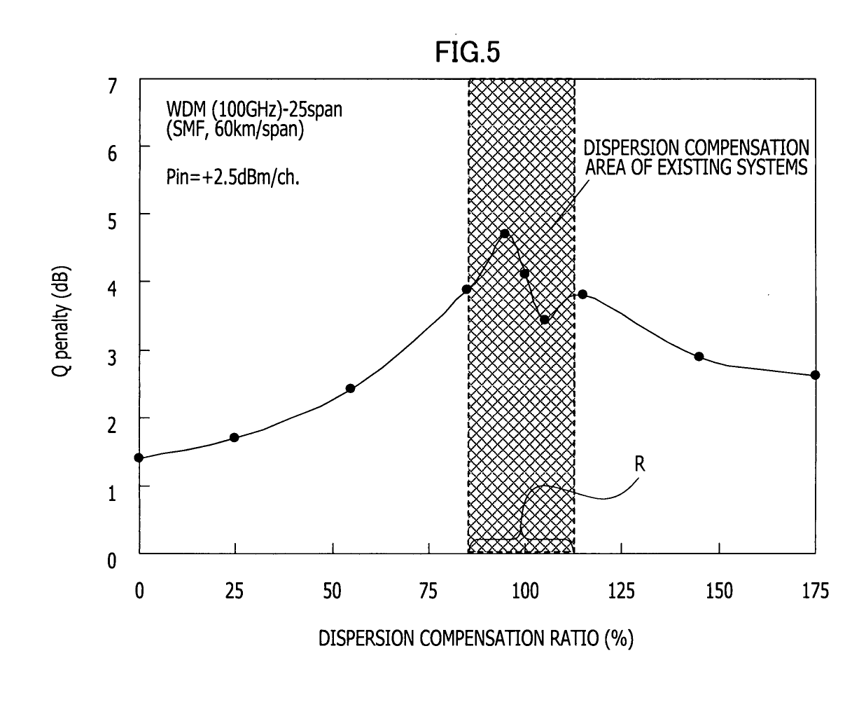

FIG. 5 illustrates an exemplary study on transmission characteristics in the digital coherent reception method. In a receiver using the digital coherent reception method, the value of a Q penalty indicating the deterioration of received signal quality increases as illustrated by an area R surrounded by a dashed line in the figure when dispersion compensation with a dispersion compensation ratio of about 100% is performed in a repeater span as before. In addition, in the area R, it is expected that a small variation in the compensation ratio causes a large variation in the signal quality.

In the receiver unit Rx of the transmission apparatus 12 of an embodiment, a dispersion amount is provided by the dispersion compensating module 13e of the transmission apparatus 16 to light corresponding to a wavelength for which reception processing is to be performed using the digital coherent reception method. Hence, the dispersion compensation ratio for light corresponding to this wavelength can be made to be about 0% in FIG. 5 even when using the optical transmission line 13 for which the dispersion compensation illustrated in FIG. 4 is applied. Accordingly, a Q penalty corresponding to a dispersion compensation ratio of about 0% can be obtained, whereby the received signal quality can be significantly improved. Note that the optical amplifier 13a may appropriately be provided in a stage subsequent to the dispersion compensating module 13e.

In the transmission apparatus 16 provided in a repeater stage, the above-described dispersion amount in accordance with a reception method can be provided by recognizing the type of reception method applied to each wavelength in the receiver unit Rx. Hence, the transmission apparatus 16 is provided with an information collection unit 13g and a controller 13h.

The information collection unit 13g provided in the transmission apparatus 16 receives information from an information extraction unit 23 and collects information regarding a reception method applied to each wavelength in the receiver unit Rx for a WDM optical signal input from the optical transmission line 13. The controller 13h performs, for each wavelength, selection and switching control to selectively guide an optical signal from an input port to the output port in the wavelength selector switch 13d, based on the information collected by the information collection unit 13g.

Accordingly, the controller 13h, the wavelength selector switch 13d, the branching unit 13c, and the dispersion compensating modules 13b and 13e constitute a chromatic dispersion providing unit that provides respective chromatic dispersion amounts different from each other to an optical signal having a wavelength for which reception is performed using the digital coherent reception method and an optical signal having a wavelength for which reception is performed using a reception method other than the digital coherent reception method based on the information regarding a reception method collected by the information collection unit 13g.

In this case, optical propagation components including the path A starting from the branch node of the spritter 13c-1 and extending to the output of the wavelength selector switch 13d correspond to a first providing unit. Optical propagation components including the path B starting from the branch node of the spritter 13c-1 and extending through the branch node of the spritter 13c-2 and the dispersion compensating module 13e to the output of the wavelength selector switch 13d correspond to a second providing unit.

The first providing unit provides one of the branch optical signals output from the branching unit 13c with a chromatic dispersion amount corresponding to an optical signal to which a reception method (direct detection method, for example) other than the digital coherent reception method is applied. The second providing unit provides the other of the branch optical signals output from the branching unit 13c with a chromatic dispersion amount corresponding to an optical signal to which the digital coherent reception method is applied as a reception method.

In the wavelength selector switch 13d, the WDM optical signals output from the first and second providing units are input from different input ports, and are selectively output through switching of the input ports, from which the WDM signals have been input, on a wavelength by wavelength basis and based on the information collected by the information collection unit 13g. The controller 13h performs selection and switching control of the input ports, having received the signals, of the wavelength selector switch 13d for each output wavelength, based on the information collected by the information collection unit 13g.

The information extraction unit 23 may be provided in a management apparatus such as an NMS that manages the illustrated whole optical transmission system, the transmission apparatus 12 including the receiver unit Rx, or the transmission apparatus 16 as a repeater. The method of transmitting information from the information extraction unit 23 to the information collection unit 13g may be for example, transmission using a control network different from a data transmission network or transmission using a monitor channel.

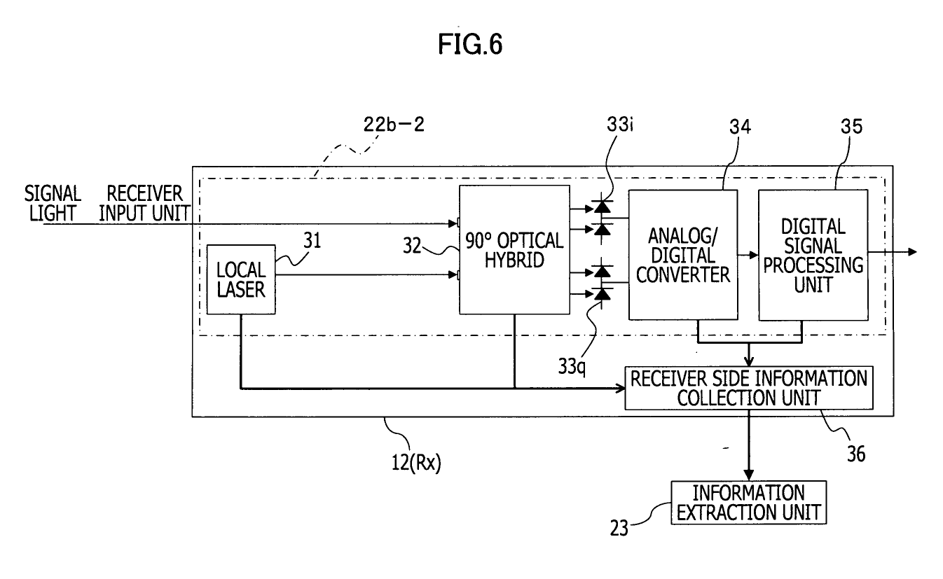

FIG. 6 illustrates an exemplary configuration of a receiver 22b-2 using the digital coherent reception method and an exemplary method of transmitting control information from the receiver 22b-2 to the information extraction unit 23. Referring to FIG. 6, the receiver 22b-2 includes a local laser source 31 which is a local oscillator light source, a 90° optical hybrid 32, balanced receivers (twin photo diodes) 33i and 33q, an analog/digital converter 34, and a digital signal processing unit 35.

In the 90° optical hybrid 32, quadrature-phase optical signals corresponding to a signal input from the demultiplexer 22a having the wavelength to be received interfere with local laser beams having corresponding phases, and an in-phase (I) optical signal and a quadrature-phase (Q) optical signal are output. The output optical signals are respectively converted to electrical signals by the twin photo diodes 33i and 33q.

The analog/digital converter 34 converts the I signal and Q signal, having been converted to electrical signals by the twin photo diodes 33i and 33q, to digital signals, and outputs them to the digital signal processing unit 35. In the digital signal processing unit 35, transmission data is recovered by demodulation based on the digital signals output from the analog/digital converter 34. At this time, dispersion compensation distortion generated on the optical transmission line 13 is compensated for. Here, a single photodiode also functions similarly to the twin photodiodes.

A receiver side information collection unit 36, provided as a component of a receiver side transmission apparatus (here, the transmission apparatus 12), integrates information from the components 31, 32, 34, and 35 including the above-described receiver 22b-2, and transmits the integrated information to the information extraction unit 23. In the information extraction unit 23, the information transmitted from the receiver side information collection unit 36 can be used as determination information for determining whether or not the receiver 22b-2 is in operation.

The receiver side information collection unit 36 illustrated in FIG. 6, collects and transmits to the information extraction unit 23 information such as the operation flag of the local laser source 31 and the internal monitoring signal of a local laser power in addition to the above-described integrated information. Alternatively, by providing a spritter, a monitor PD, and the like between the local laser source 31 and the 90° optical hybrid 32, information regarding the local laser power is monitored by the monitor PD and transmitted to the information extraction unit 23, or by storing reception methods used in the receivers 22b in the receiver unit Rx in advance on a channel by channel basis, the correspondence between the channels and reception methods may be transmitted to the information extraction unit 23 as required. These techniques also make it possible for the information collection unit 13g (in a repeater stage) to identify or determine the reception methods on the receiver side.

Thereby, the information collection unit 13g of the transmission apparatus 16 can determine the reception methods of the receivers 22b in operation based on the information received via the information extraction unit 23. The controller 13h controls the wavelength selector switch 13d based on the determination results from the information collection unit 13g such that light having a wavelength for which reception is to be performed by the receiver 22b-2 using the digital coherent reception method is repeated via a route passing through the dispersion compensating module 13e.

For example, the inputs of the wavelength selector switch 13d input through the paths A and B illustrated in FIG. 1 include optical signals of all the wavelengths including the input WDM optical signal. Regarding optical signals having wavelengths for which the digital coherent reception method is applied, the wavelength selector switch 13d passes the optical signals input through the path B to the output port while the signals input through the path A are blocked. On the other hand, regarding optical signals having wavelengths for which a reception method other than the digital coherent reception method is applied, the wavelength selector switch 13d passes the optical signals input through the path A to the output port while the signals input through the path B are blocked.

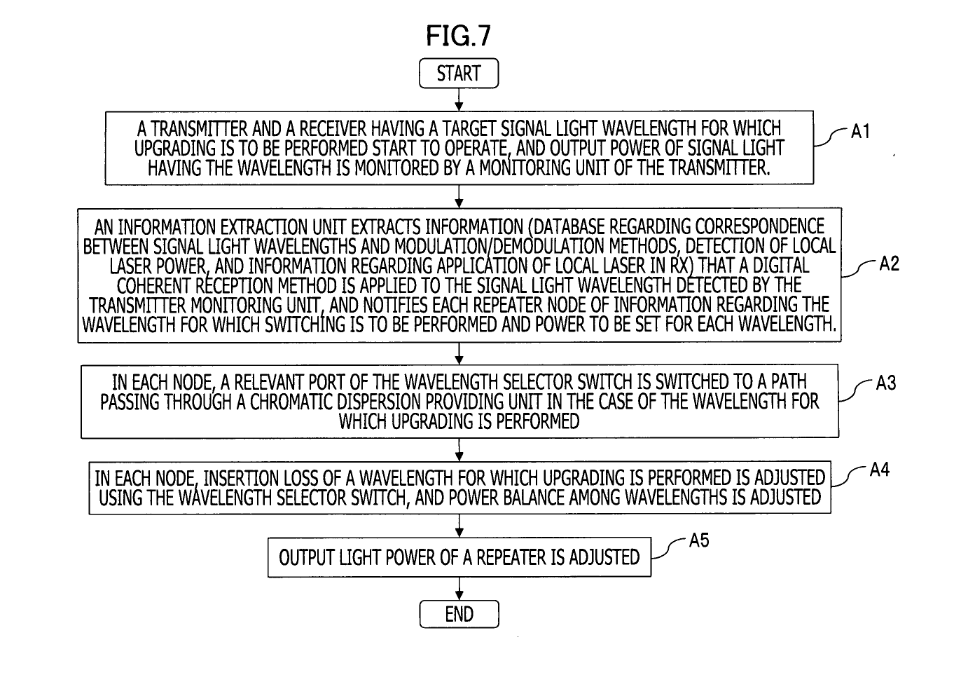

FIG. 7 illustrates a case in which the receiver 22b using the operation wavelength of the receiver unit Rx is upgraded to a receiver using the digital coherent reception method (22b-2 in FIG. 6, for example) in the optical communications system configured as described above.

The case in which the receiver 22b for a certain wavelength in the receiver unit Rx is upgraded to the receiver 22b-2 that uses the digital coherent reception method, or the case in which one wavelength for which the digital coherent reception method is used is added to the wavelengths used in WDM are assumed. At this time, when the transmitter 21a (for example, in the transmission apparatus 11) and the receiver 22b-2 (for example, in the transmission apparatus 12) using the wavelength corresponding to the upgrading start to operate, the information extraction unit 23 recognizes the start of the operations (step A1). For example, the transmitter 21a monitors the optical output power value with a monitor unit and transmits the operation state to the information extraction unit 23 as a monitor signal. The monitor signal may include information about a monitored power value.

The information extraction unit 23, upon receiving the information such as a monitor control signal transmitted from the transmitters 21a and the receiver 22b-2, recognizes that the transmitter 21a and the receiver 22b-2 have entered an operation state. Specifically, it is recognized that the receiver 22b which has entered an operation state uses the digital coherent reception method, based on information, transmitted from the receiver 22b-2, about the operation flag of the local laser source 31 and the monitor signal regarding the local laser power.

When it is recognized in the information extraction unit 23 that the receiver 22b which has entered an operation state uses the digital coherent reception method, the information extraction unit 23 informs the transmission apparatus 16 of information about the wavelength for which path switching is to be performed in the wavelength selector switch 13d and a power set for each wavelength. When a plurality of the transmission apparatuses 16 are provided on the optical transmission line 13, notification is similarly performed for each of the transmission apparatuses 16 (operation A2).

Thereby, the information collection unit 13g of the transmission apparatus 16 identifies and recognizes the receiver 22b-2 in operation based on the information received through the information extraction unit 23. In other words, the information collection unit 13g collects, as reception method information, the operation state of the local laser source 31, which is used when the digital coherent reception method is applied, for each reception wavelength in the receiver unit Rx.

The controller 13h of the transmission apparatus 16 performs switching control of the ports of the wavelength selector switch 13d based on the identification result provided from the information collection unit 13g such that light having the wavelength to be received by the receiver 22b-2 is repeated through a path via the dispersion compensating module 13e (operation A3).

In the case of adding a wavelength in WDM, the information extraction unit 23 collects information regarding the reception method used for the wavelength to be added, and the chromatic dispersion providing unit sets a chromatic dispersion amount to be provided to an optical signal having the wavelength to be added.

The controller 13h of the transmission apparatus 16 has a function of adjusting and controlling the power balance among optical signals having respective wavelengths output from the wavelength selector switch 13d. The power balance among respective wavelengths can be adjusted by adjusting the input loss of the wavelength for which the receiver 22b-2 is to be changed, using the selector switch 13d under the control of the controller 13h (operation A4). In addition, the controller 13h adjusts the output power of the transmission apparatus 16 as required, for example, through controlling of the optical amplifier 13a (operation A5).

As described above, according to an embodiment, even when using a transmission line having a repeater stage that performs dispersion compensation, the dispersion compensation ratio can be shifted from the area R illustrated in FIG. 5 when the digital coherent reception method is applied, whereby deterioration in the quality of received signals is suppressed or the quality of received signals is improved.

Various modifications of an exemplary embodiment are within the disclosed scope.

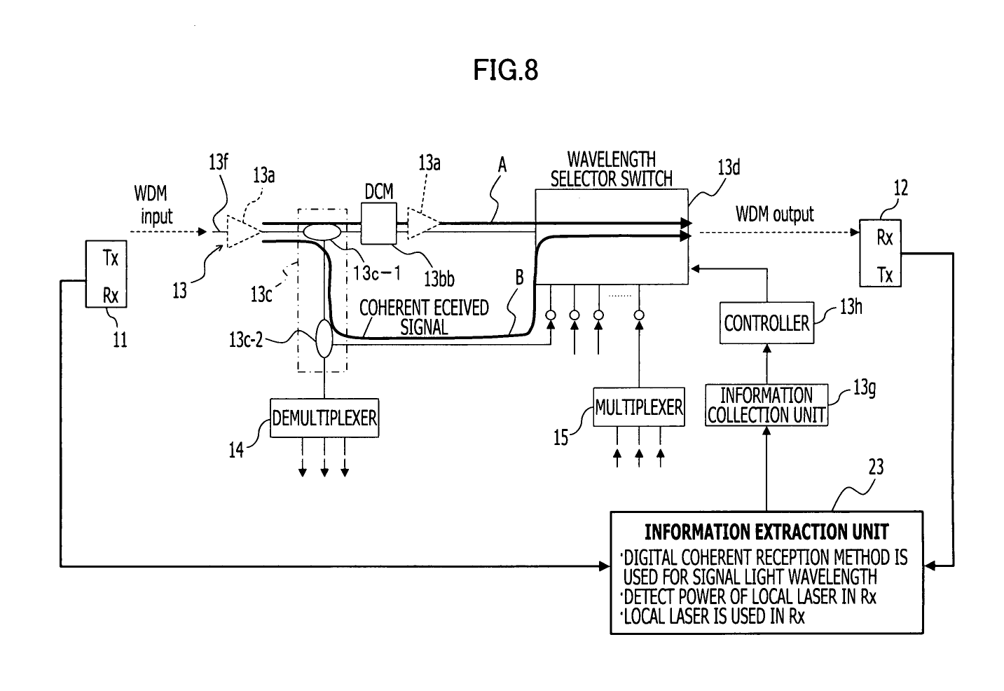

Referring to FIG. 8, when the dispersion compensating module 13b provided in a stage prior to the branching unit 13c in FIG. 1 is not provided, a chromatic dispersion providing unit having a configuration different from the one illustrated in FIG. 1 is provided. That is, a dispersion compensating module 13bb is provided on the path A connecting the branch node of the spritter 13c-1 and the wavelength selector switch 13d to each other, while the dispersion compensating module 13e provided on the path B connecting the branch node of the spritter 13c-2 and the wavelength selector switch 13d to each other is omitted.

In other words, the above-described dispersion compensating module 13bb provided on the path A performs dispersion compensation using a dispersion compensation ratio (for example, about 100%) corresponding to a reception method (for example, direct detection method) other than the digital coherent reception method. On the other hand, dispersion compensation on the path B in a repeater stage is omitted in correspondence with the digital coherent reception method.

Thereby, the quality of received optical signals having wavelengths for which the digital coherent reception method is used is improved by the controller 13h controlling the path selection of the wavelength selector switch 13d similarly to FIG. 1. Components in FIG. 8 similar to those in FIG. 1 are denoted by the same reference numerals.

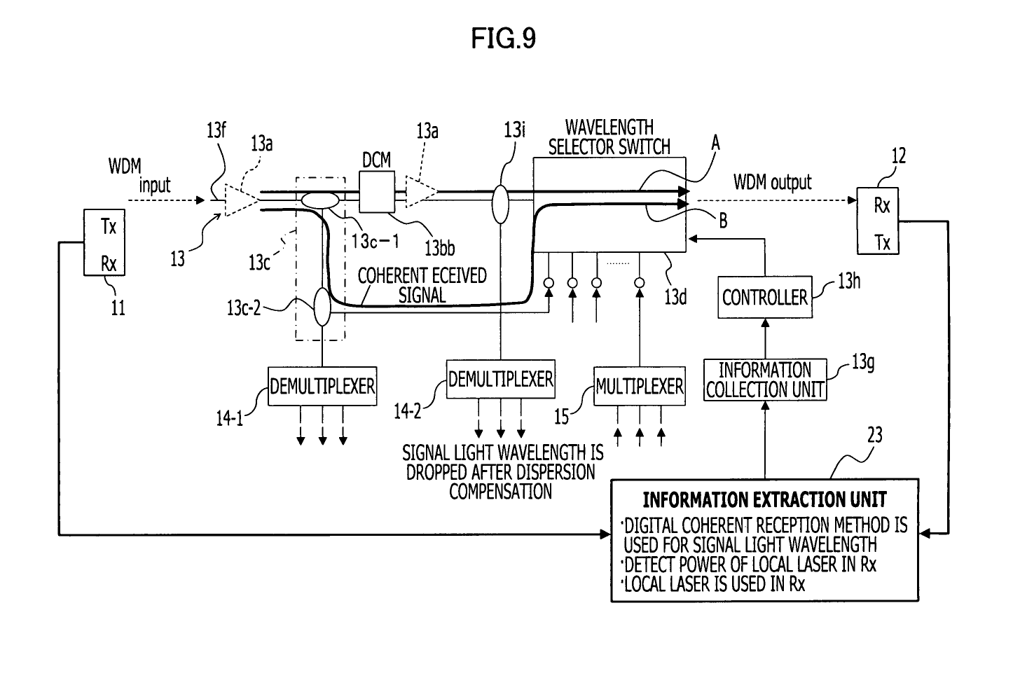

Referring to FIG. 9, a configuration may be provided that performs division and dropping for a signal after the signal has been compensated for dispersion by the dispersion compensating module 13bb and before the signal is input to the wavelength selector switch 13d, in FIG. 8. In other words, a spritter 13i is provided between the branch node of the spritter 13c-2 and the wavelength selector switch 13d, and drops part of the optical signal to be input to the wavelength selector switch 13d.

An optical signal having a wavelength to be dropped which has been taken out by the demultiplexer 14-1 through demultiplexing of the light provided from the branching unit 13c is an optical signal which has not been compensated for dispersion by the dispersion compensating module 13b as illustrated in FIG. 1. On the other hand, an optical signal having a wavelength to be dropped which has been taken out by the demultiplexer 14-2 through demultiplexing of the light provided from the spritter 13i is an optical signal which has been compensated for dispersion by the dispersion compensating module 13bb.

In other words, optical signals which are either compensated or not compensated for dispersion on the optical transmission line 13 can be taken out as dropped light in accordance with reception methods. For example, optical signals obtained by the demultiplexer 14-1 through demultiplexing are used for optical signals having wavelengths for which reception is to be performed using the digital coherent reception method, and optical signals obtained by the demultiplexer 14-2 through demultiplexing are used for optical signals having wavelengths for which reception is to be performed using a direct detection method. In FIG. 9, components similar to those described before are denoted by the same reference numerals.

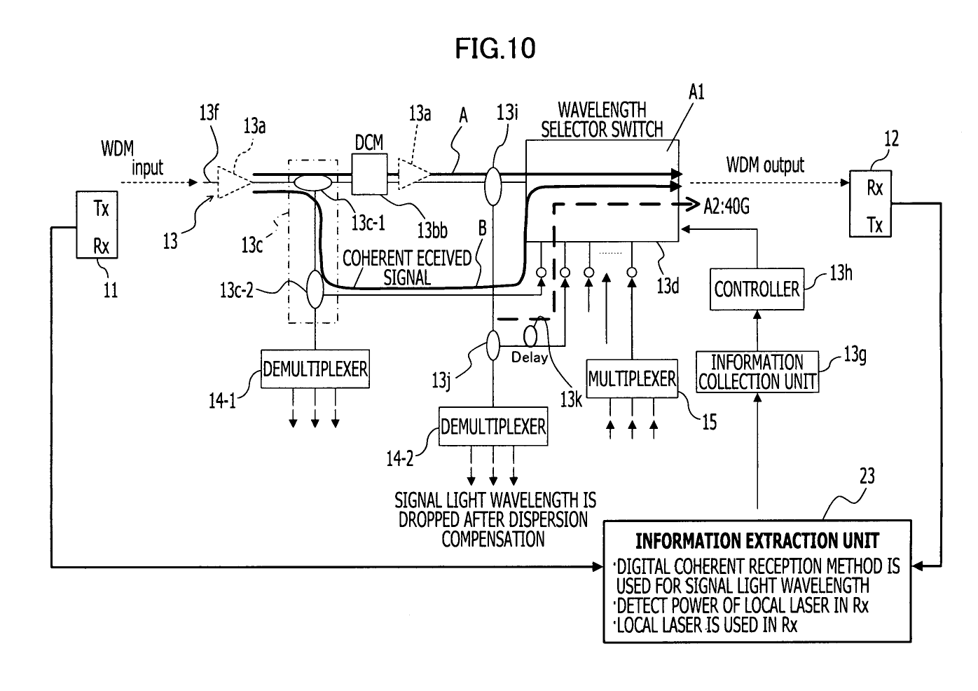

Further, referring to FIG. 10, a spritter 13j may further be provided between the branch node of the spritter 13i and the demultiplexer 14-2 with part of the spritter 13j being connected to an input port of the wavelength selector switch 13d. Thereby, two paths A1 and A2 can be set up as paths for an optical signal which is compensated for dispersion by the dispersion compensating module 13bb. That is, the first path A1 is a path connected to the wavelength selector switch 13d through the spritter 13i, and the second path A2 is a path connected to the wavelength selector switch 13d through the two spritters 13i and 13j.

A delay line 13k is provided on a path between the spritter 13j and the wavelength selector switch 13d including the second path A2. For example, the first path A1 is set up as a path for passing therethrough, for example, a 10 Gbps strength modulation optical signal among the optical signals having wavelengths for which a direct detection method is used, while the second path A2 is set up as a path for passing therethrough, for example, a 40 Gbps strength modulation optical signal among the optical signals having wavelengths for which a direct detection method is used.

Similarly to FIGS. 1, 8, and 9 shown above, the path B which does not pass through the dispersion compensating module 13bb is used for transmitting optical signals having wavelengths for which the digital coherent reception method is applied. This allows for suppression of the influence of a nonlinear effect such as cross-phase modulation (XPM) on the optical signals of the neighboring channels among the optical signals having wavelengths for which reception is to be performed using a direct detection method. Note that components in FIG. 10 similar to those described before are denoted by the same reference numerals.

In other words, also in the configuration illustrated in FIG. 10, advantages similar to those in FIG. 1 are obtained, and by setting up the above-described paths A1, A2, and B, a delay amount or dispersion amount can be set differently in accordance with bit rates and reception methods. This allows red chirp and blue chirp generated in the neighboring channels due to XPM to cancel out each other. Conventionally, a cancelling out of the amounts of generated chirp is described in Japanese Laid-open Patent Publication No. 2008-167297, for example.

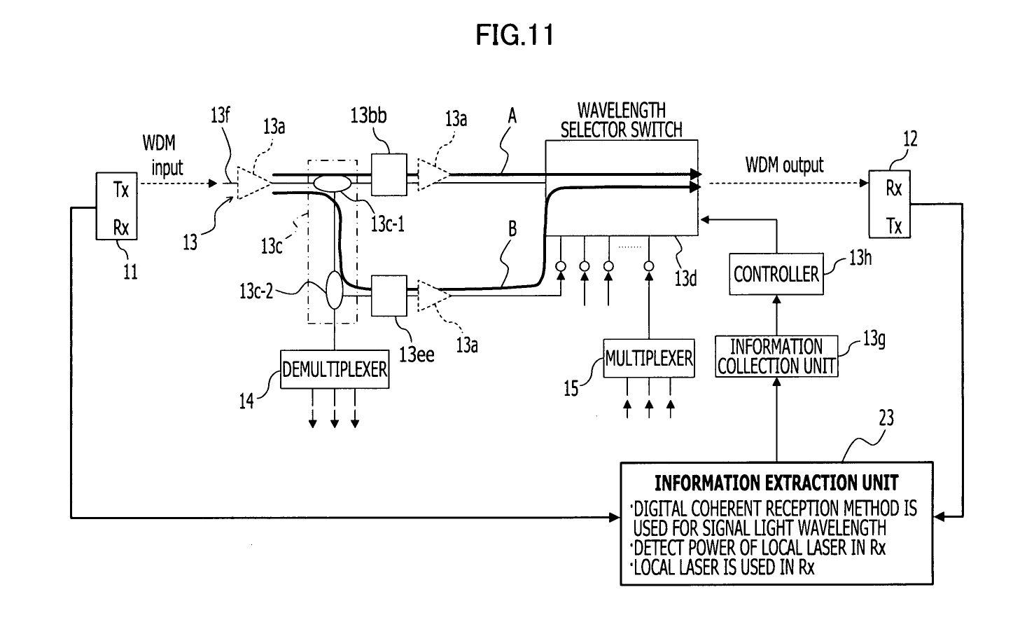

Further, referring to FIG. 11, a dispersion compensating module 13ee for optical signals having wavelengths to which the digital coherent reception method is applied may be provided on the path B extending through the spritters 13c-1 and 13c-2 and the wavelength selector switch 13d in FIG. 8, shown above. When the dispersion compensating module 13ee provides a dispersion amount corresponding to a compensation ratio outside of the area R illustrated in FIG. 5, at least the quality of received signals can be improved.

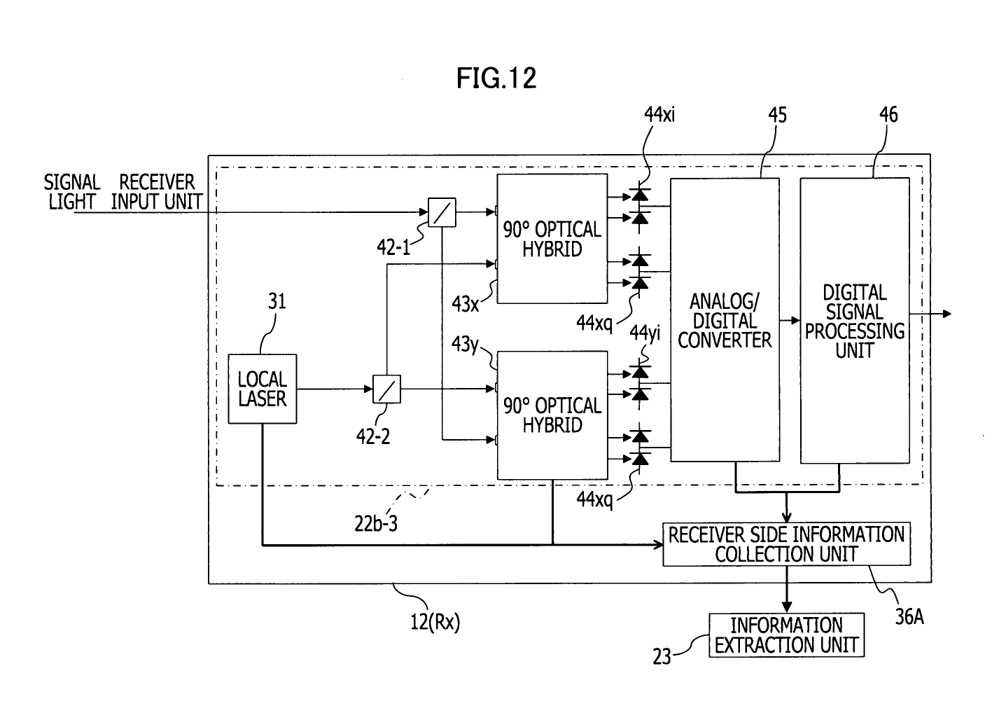

A receiver 22b-3 illustrated FIG. 12 may be used as a receiver using the digital coherent reception method, other than the one illustrated in FIG. 6. Referring to FIG. 12, the receiver 22b-3 uses polarization diversity, and includes the local laser source 31, two polarization separation devices 42-1 and 42-2, two 90° optical hybrids 43x and 43y, twin photo diodes 44xi, 44xq, 44yi, and 44yq, an analog digital converter 45, and a digital signal processing unit 46.

The polarization separation device 42-1 separates an optical signal of one channel obtained through demultiplexing performed by a demultiplexer (22a illustrated in FIG. 3) into two polarization components orthogonal to each other. Similarly, the polarization separation device 42-2 separates a laser beam output from the local laser source 31 into two polarization components orthogonal to each other.

The same-polarization components (here, X polarization components) of an optical signal and a local laser beam respectively separated by the polarization separation devices 42-1 and 42-2 through polarization separation are made to interfere with each other by the 90° optical hybrid 43x, whereby an I (in-phase) signal and a Q (quadrature-phase) signal are output. The same-polarization components (here, Y polarization components) of an optical signal and a local laser beam respectively separated by the polarization separation devices 42-1 and 42-2 through polarization separation are made to interfere with each other by the 90° optical hybrid 43y, whereby an I (in-phase) signal and a Q (quadrature-phase) signal are output. We also use a 3 dB-coupler instead of the polarization separation device 42-1 or 42-2.

The twin photodiodes 44xi and 44xq respectively receive the I signal and Q signal output from the 90° optical hybrid 43x and outputs them as electrical signals. The twin photodiodes 44yi and 44yq respectively receive the I signal and Q signal output from the 90° optical hybrid 43y and outputs them as electrical signals.

The analog/digital converter 45 converts the electrical signals respectively output from the twin photodiodes 44xi, 44xq, 44yi, and 44yq to digital signals and delivers them to the digital signal processing unit 46. Thereby, the digital signal processing unit 46 performs data demodulation by performing digital processing using the digital signals output from the analog/digital converter 45. A single photodiode may function similarly to the twin photodiodes.

A receiver side information collection unit 36A may be provided similarly to the one illustrated in FIG. 6 as a component of a receiver side transmission apparatus (here, the transmission apparatus 12), and integrates information from the components 42-1, 42-2, 43x, 43y, 45, and 46 including the above-described receiver 22b-3 and transmits the integrated information to the information extraction unit 23. In the information extraction unit 23, the information transmitted from the receiver side information collection unit 36A can be used as determination information for determining whether or not the receiver 22b-3 is in operation.

The receiver side information collection unit 36A collects and transmits to the information extraction unit 23 information such as the operation flag of the local laser source 31 and the internal monitoring signal of a local laser power in addition to the above-described integrated information. Alternatively, by providing a spritter, a monitor PD, and the like between the local laser source 31 and the polarization separation device 42-2, information regarding the local laser power is monitored by the monitor PD and transmitted to the information extraction unit 23, or by storing reception methods used in the receivers 22b in the receiver unit Rx in advance on a channel by channel basis, the correspondence between the channels and reception methods may be transmitted to the information extraction unit 23 as required. These techniques also make it possible for the information collection unit 13g (in a repeater stage) to identify or determine the reception methods on the receiver side.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of an invention have been described in detail, it should be understood that the various changes, substitutions, and alterations could be made hereto without departing from the spirit and scope of the invention. The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A transmission apparatus in a transmission system that performs dispersion compensation on a transmission line, the apparatus comprising:
a receiver to receive a wavelength division multiplexing optical signal for each wavelength from the transmission line;
an information collection unit to collect information regarding a reception method that had been applied to each wavelength of the optical signal received by the receiver, as reception method information; and
a chromatic dispersion providing unit that provides respective chromatic dispersion amounts different from each other to an optical signal received that used a digital coherent reception method and an optical signal received that used a reception method other than the digital coherent reception method, based on the information regarding a reception method collected by the information collection unit.

2. The transmission apparatus according to claim 1, wherein the chromatic dispersion providing unit includes:
a spritter to divide the input WDM signal into a first optical signal and a second optical signal;
a first providing unit to provide the first optical signal with a chromatic dispersion amount to be used in a reception method other than the digital coherent reception method,
a second providing unit to provide the second optical signal with a chromatic dispersion amount to be used in the digital coherent reception method,
a wavelength selection switch which receives from different input ports thereof an optical signal output from the first providing unit and an optical signal output from the second providing unit, and outputs the received signals by selectively switching the input ports receiving the signals on a wavelength by wavelength basis, and
a controller to perform selective switching control of the input ports receiving the signals for each output wavelength based on the information collected by the information collection unit.

3. The transmission apparatus according to claim 1,
wherein, when a wavelength in the wavelength multiplexing is added, the information collection unit collects information regarding a reception method for the wavelength to be added, and
wherein the chromatic dispersion providing unit sets a chromatic dispersion amount provided to an optical signal having the wavelength to be added, based on the collected information.

4. The transmission apparatus according to claim 1, wherein the information collection unit collects, for each reception wavelength in the receiver, information regarding an operation state of a local oscillator light source which is used when the digital coherent reception method is used as the reception method, as the reception method information.

5. The transmission apparatus according to claim 1, further comprising:
a memory to store information regarding the reception method used in the receiver for each reception wavelength,
wherein the information collection unit collects the reception method information by referring to content of the memory.

6. A transmission system for performing dispersion compensation on a transmission line, comprising:
a receiver to receive from the transmission line a wavelength division multiplexing optical signal for each wavelength;
an information collection unit to collect information regarding a reception method that was applied to each wavelength of the optical signal received by the receiver, as reception method information; and
a chromatic dispersion providing unit that provides respective chromatic dispersion amounts different from each other to an optical signal received that used a digital coherent reception method and an optical signal received that used a reception method other than the digital coherent reception method based on the reception method information collected by the information collection unit.

7. A method of communication in a transmission system that performs dispersion compensation on a transmission line, the method comprising:
receiving from the transmission line a wavelength division multiplexing optical signal for each wavelength;
collecting information regarding a reception method applied to each wavelength of the received optical signal as reception method information;
selecting, for each wavelength, a first path or a second path in accordance with the applied reception method, based on the collected reception method information; and
providing respective chromatic dispersion amounts different from each other to an optical signal received using a reception method other than a digital coherent reception method, on the first path, and to an optical signal received using the digital coherent reception method, on the second path.

8. The method of communication according to claim 7, wherein, for each reception wavelength in the receiver, information regarding an operation state of a local oscillator light source which is used when the digital coherent reception method is used as the reception method, is collected as the reception method information.

9. The method of communication according to claim 7, further comprising:
storing information regarding the reception method used for the received optical signal, for each reception wavelength,
wherein the reception method information is collected by referring to the stored information.

10. The method of communication according to claim 7,
wherein, when a wavelength in the wavelength multiplexing is added, information regarding a reception method for the wavelength to be added is collected,
wherein a path for the added wavelength is set by the selecting based on the collected information regarding a reception method, and
wherein a chromatic dispersion amount set for an optical signal having the wavelength to be added is provided on the selected path.

11. A method of communication in a transmission system, the method comprising:
receiving a wavelength division multiplexing optical signal including information regarding a reception method applied to a plurality of wavelengths of the received optical signal;
selecting, for each of the plurality of wavelengths, a first path or a second path based on the collected reception method information; and
providing respective chromatic dispersion amounts different from each other to an optical signal received using a reception method other than a digital coherent reception method, on the first path and on the second path.
